(19) United States
(12) Patent Application Publication
(10) Pub. No.: US 2011/0177411 A1
(43) Pub. Date: Jul. 21, 2011

(54) HYDROGEN GAS GENERATOR AND FUEL CELL WITH THE HYDROGEN GAS GENERATOR

(75) Inventors: Yueh-Chang Wu, Hsinchu County (TW); Cheng Wang, Hsinchu County (TW); Po-Kuei Chou, Hsinchu County (TW)

(73) Assignee: YOUNG GREEN ENERGY CO., HSINCHU COUNTY (TW)

(21) Appl. No.: 12/959,385

(22) Filed: Dec. 3, 2010

(30) Foreign Application Priority Data
Jan. 15, 2010 (CN) 201010002980.0

(51) Int. Cl. H01M 8/06; B01J 19/00

(52) U.S. Cl. 429/426; 422/129

(57) ABSTRACT

A hydrogen gas generator suitable for a fuel cell is provided. The hydrogen gas generator includes a container and a capillary structure. The capillary structure is disposed between the container and a flexible solid fuel, wherein the container is capable of accommodating liquid water, and the liquid water accommodated in the container is capable of being transferred to the flexible solid fuel by the capillary structure so as to react with the flexible solid fuel to generate hydrogen gas.

### CROSS-REFERENCE TO RELATED APPLICATION

This application claims the priority benefit of China application serial no. 201010002980.0, filed on Jan. 15, 2010. The entirety of the above-mentioned patent application is hereby incorporated by reference herein and made a part of this specification.

### BACKGROUND OF THE INVENTION

1. Field of the Invention

The invention generally relates to a hydrogen gas generator and a fuel cell with the hydrogen gas generator, and more particularly, to a hydrogen gas generator using a solid fuel and a fuel cell with the hydrogen gas generator.

2. Description of Related Art

The fuel cell (FC) is an electrical generating apparatus to directly convert chemical energy into electrical energy. In comparison with the traditional electrical generating apparatus, the fuel cell is advantageous in low pollution, low noise, high energy density, and higher efficiency of converting energy. The fuel cell is a clean energy with the great future prospect and applicable to those including portable electronic products, home electrical generating system, transportation means, military equipments, space industry and small electrical generating system, and so on.

Depending on different operation principles and operation environments, different fuel cells have different application markets, wherein a so-called moveable energy source wins its applications mainly in forms of hydrogen gas proton exchange membrane fuel cell (hydrogen gas PEMFC) and direct methanol fuel cell (DMFC). Both of them use a proton exchange membrane to perform proton conducting mechanism and belong to the category of low-temperature-started fuel cell. Based on the operation principle of PEMFC in the types, the hydrogen gas conducts oxidation reaction at the anode catalyst layer to generate hydrogen ions (H⁺) and electrons (e⁻) (briefing as PEMFC principle), or the methanol and the water conduct oxidation reaction at the anode catalyst layer to generate hydrogen ions (H⁺), carbon dioxide (CO₂), and electrons (e⁻) (briefing as DMFC principle). The hydrogen ions (H⁺) herein may be transferred to the cathode through the proton conducting membrane, while the electrons are transferred to a load through an external circuit to do work, followed by being transferred to the cathode. At the time, the oxygen gas supplied to the cathode terminal would together with the hydrogen ions and the electrons conduct reduction reaction at the cathode catalyst layer so as to generate water. The required fuel hydrogen gas at the above-mentioned anode may be obtained with hydrogen-storing technique by means of solid sodium borohydride (NaBH₄), where water is added into the solid sodium borohydride so as to generate hydrogen gas by reactions.

The related patents may refer, for example, U.S. Pat. Nos. 6,746,496, 7,306,780, and 7,427,302.

The reaction of solid sodium borohydride and water is a one-off reaction, which means once the reaction is started, the reaction must be continued until solid sodium borohydride or water is completely consumed. Therefore, how to realize reactions in phases becomes a task to be solved.

### SUMMARY OF THE INVENTION

Accordingly, the invention is directed to a hydrogen gas generator, wherein the solid fuel and the water are able to be reacted slowly so as to stably release hydrogen gas.

The invention is also directed to a fuel cell, wherein the solid fuel and the water of the hydrogen gas generator are able to be reacted slowly so as to stably release hydrogen gas.

Other advantages of the invention should be further indicated by the disclosures of the invention.

To achieve one of, a part of or all of the above-mentioned advantages, or to achieve other advantages, an embodiment of the invention provides a hydrogen gas generator suitable for a fuel cell. The hydrogen gas generator includes a container, a capillary structure, and an elastic bag-like body. The capillary structure is disposed between the container and a flexible solid fuel, wherein the container is capable of accommodating liquid water, and the liquid water accommodated in the container is capable of being transferred by the capillary structure to the flexible solid fuel and reacts together with the flexible solid fuel to generate hydrogen gas.

To achieve one of, a part of or all of the above-mentioned advantages, or to achieve other advantages, an embodiment of the invention provides a fuel cell, the fuel cell includes a hydrogen gas generator, a cell pile, and a guiding structure. The hydrogen gas generator includes a container, a capillary structure, and an elastic bag-like body. The capillary structure is disposed between the container and a flexible solid fuel, wherein the container is capable of accommodating liquid water, and the liquid water accommodated in the container is capable of being transferred by the capillary structure to the flexible solid fuel and reacts together with the flexible solid fuel to generate hydrogen gas. The guiding structure is connected between the hydrogen gas generator and the cell pile and capable of guiding the hydrogen gas generated by the reaction of the solid fuel and the liquid water to the cell pile.

Based on the depiction above, in the above-mentioned embodiment of the invention, the liquid water may be durably transferred to the flexible solid fuel through the capillary structure, so that the flexible solid fuel and the liquid water are slowly reacted to stably release the hydrogen gas.

Other objectives, features and advantages of the invention will be further understood from the further technological features disclosed by the embodiments of the invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a diagram of a hydrogen gas generator according to an embodiment of the invention.

FIG. 2 is a diagram showing the elastic bag-like body of FIG. 1 shrunk with consuming the liquid water.

FIG. 3 is a diagram of a hydrogen gas generator according to another embodiment of the invention.

FIG. 4 is a diagram of a hydrogen gas generator according to yet another embodiment of the invention.

FIG. 5 is a diagram showing operation of the switch assembly of FIG. 4.

FIG. 6 is a diagram of a hydrogen gas generator according to yet another embodiment of the invention.

FIG. 7 is a diagram of a hydrogen gas generator according to yet another embodiment of the invention.

FIG. 8 is a diagram showing the elastic bag-like body of FIG. 7 expanded with consuming the liquid water.

FIG. 9 is a diagram of a fuel cell with the hydrogen gas generator in FIG. 1.

### DESCRIPTION OF THE EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the invention may be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

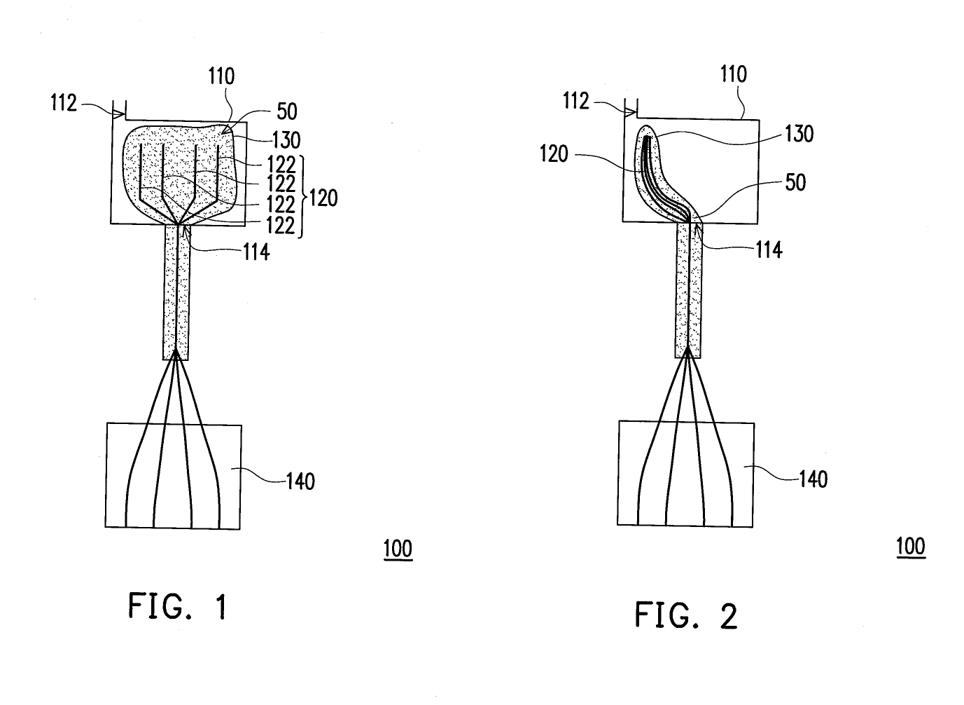

FIG. 1 is a diagram of a hydrogen gas generator according to an embodiment of the invention. Referring to FIG. 1, the hydrogen gas generator 100 of the embodiment is suitable for a fuel cell to provide the hydrogen gas for the anode reaction of the fuel cell. The hydrogen gas generator 100 includes a container 110, a capillary structure 120, and a elastic bag-like body 130. The capillary structure 120 transfers liquid water 50 to a solid fuel 140, and the elastic bag-like body 130 may be expanded or shrunk with the volume variation of the liquid water 50 so as to keep the liquid water 50 contacting the capillary structure 120. In the embodiment, the solid fuel 140 is, for example, a flexible solid sodium borohydride which has a diameter, for example, greater than or substantially equal to 1 mm so as to become a structure able to evenly contact the capillary structure 120. However, the invention is not limited to the above-mentioned structure. In fact, the solid fuel 140 may be also a flexible solid fuel in other types.

The capillary structure 120 is disposed between the container 110 and the solid fuel 140, wherein the container 110 is capable of accommodating the liquid water 50, and the liquid water 50 accommodated in the container 110 is transferred by the capillary structure 120 to the solid fuel 140 so as to slowly react with the solid fuel 140 to stably generate the hydrogen gas.

In another embodiment, the capillary structure 120 is disposed in the container 110 and a part of the capillary structure 120 extends to the outside of the container 110. The elastic bag-like body 130 is disposed in the container 110, where the user may pull the liquid water 50 into the container 110 so that the liquid water 50 contacts the elastic bag-like body 130 and the capillary structure 120. The solid fuel 140 is disposed outside the container 110 and contacts the capillary structure 120 extending to outside the container 110. The liquid water 50 accommodated in the container 110 is transferred to the solid fuel 140 by the capillary structure 120 so as to slowly react with the solid fuel 140 to stably generate the hydrogen gas.

FIG. 2 is a diagram showing the elastic bag-like body of FIG. 1 shrunk with consuming the liquid water. Referring to FIGS. 1 and 2, the container 110 in the embodiment has an air-permeable opening 112 and a fluid-guiding opening 114. The container 110 is communicated with the outside through the air-permeable opening 112, the capillary structure 120 is disposed in the elastic bag-like body 130, and the fluid-guiding opening 114 is communicated with the elastic bag-like body 130 so that the capillary structure 120 is able to extend to the outside of the container 110 through the fluid-guiding opening 114. The liquid water 50 may be gradually consumed and accordingly change the status thereof from the status of FIG. 1 to the status of FIG. 2; the elastic bag-like body 130 may be shrunk with the consumption of the liquid water 50 under the atmosphere pressure from the status of FIG. 1 to the status of FIG. 2. In this way, it is assured to make the capillary structure 120 contact the liquid water 50 and to durably transfer the liquid water 50 to the solid fuel 140 through the capillary structure 120. In addition, it should be noted that since there is no direction restriction for the capillary structure 120 to transfer liquid, the liquid water 50 may be always smoothly transferred to the solid fuel 140 through the capillary structure 120 regardless the solid fuel 140 is disposed under the container 110, over the container 110 or beside the container 110.

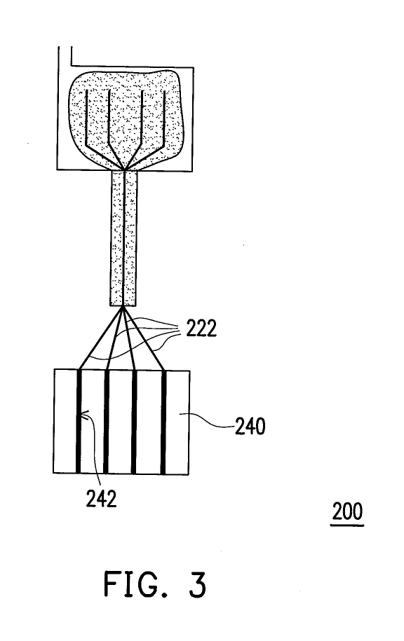

Referring to FIG. 1, in the embodiment, a disposing manner of the capillary structure 120 is selected from the group consisting of enclosing the solid fuel 140, located on the surface of the solid fuel 140 and extending into the solid fuel 140. The capillary structure 120 includes a plurality of cotton threads 122 (wicks), wherein the cotton threads 122 enclose the solid fuel 140 so as to evenly contact the solid fuel 140. FIG. 3 is a diagram of a hydrogen gas generator according to another embodiment of the invention. In the embodiment of FIG. 3, the solid fuel 240 of the hydrogen gas generator 200 has a plurality of interlayers 242, and the cotton threads 222 extend into the interlayers 242 of the solid fuel 240 to evenly contact the solid fuel 240. The invention does not limit the implementation type of the capillary structure. In other unshown embodiments, the capillary structure may be cotton net, cotton cloth or other appropriate capillary structure.

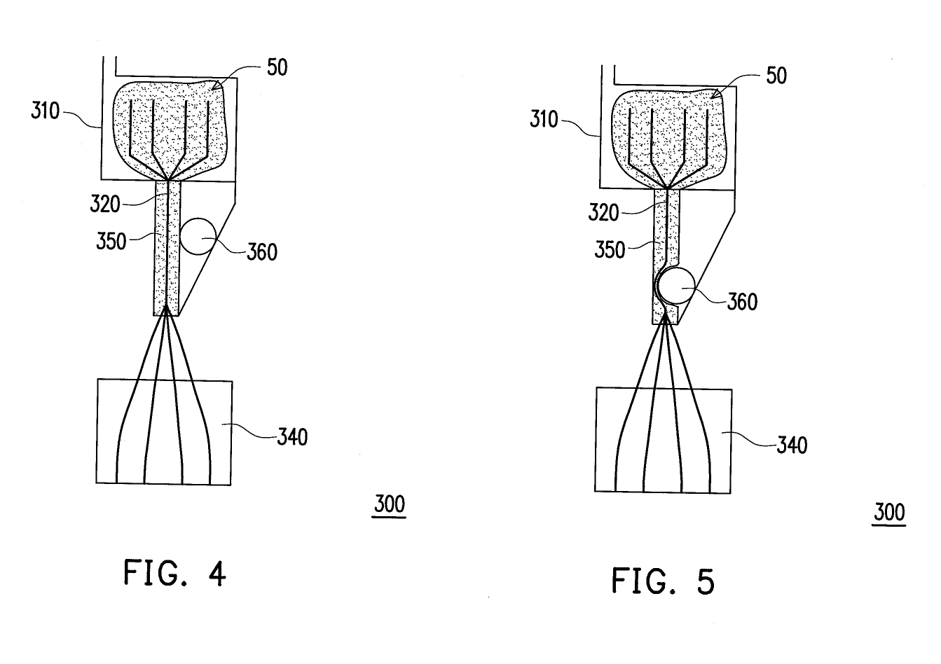

FIG. 4 is a diagram of a hydrogen gas generator according to yet another embodiment of the invention and FIG. 5 is a diagram showing operation of the switch assembly of FIG. 4. Referring to FIG. 4, in comparison with the above-mentioned embodiment, the hydrogen gas generator 300 of the embodiment has a switch assembly 360 disposed beside an elastic pipe body 350, wherein the elastic pipe body 350 is disposed between the container 310 and the solid fuel 340, and the capillary structure 320 goes through the elastic pipe body 350 and extends to the solid fuel 340. The switch assembly 360 works from the status of FIG. 4 transited to the status of FIG. 5 where the switch assembly 360 squeezes the elastic pipe body 350 for deformation so as to press the capillary structure 320 passing through the elastic pipe body 350. In this way, the capillary structure 320 ceases transferring the liquid water 50 so as to pause the reaction of the solid fuel 340 and the liquid water 50 and thereby pause generating the hydrogen gas; once the hydrogen gas needs to be supplied, the switch assembly 360 is resumed from the status of FIG. 5 to the status of FIG. 4 and at the time, the capillary structure 320 goes on to transfer the liquid water 50 to the solid fuel 340.

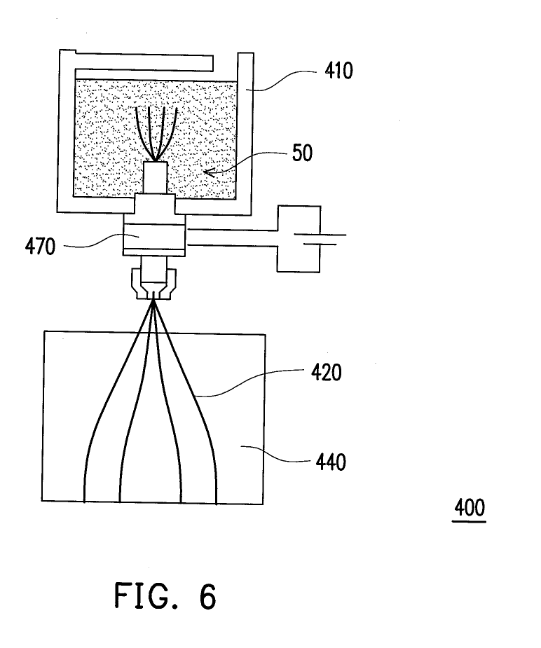

FIG. 6 is a diagram of a hydrogen gas generator according to yet another embodiment of the invention. Referring to FIG. 6, in the hydrogen gas generator 400 of the embodiment, an electroosmotic pump 470 is employed and disposed between the container 410 and the solid fuel 440 to accurately control the flow of the liquid water 50. In more details, the capillary structure 420 goes through the electroosmotic pump 470 and extends to the solid fuel 440, wherein the flow of the electrons in the electroosmotic pump 470 is used to control the transferring speed of the liquid water 50 in the capillary structure 420, so that the reaction of the liquid water 50 and the solid fuel 440 may be accelerated, decelerated or paused.

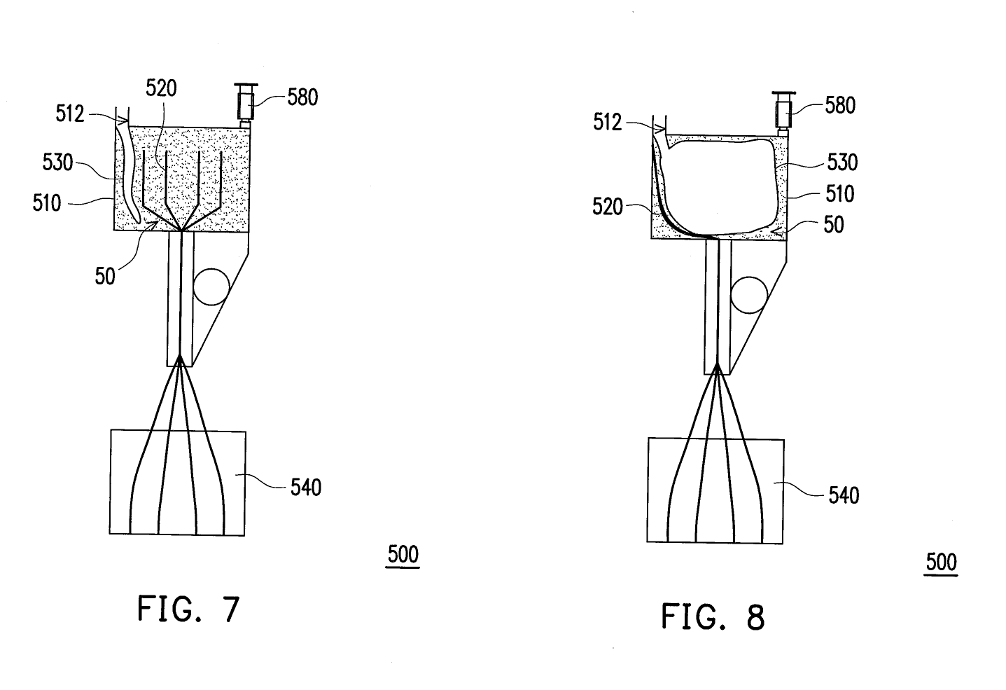

FIG. 7 is a diagram of a hydrogen gas generator according to yet another embodiment of the invention and FIG. 8 is a diagram showing the elastic bag-like body of FIG. 7 expanded with consuming the liquid water. Referring to FIG. 7, in comparison with all the above-mentioned embodiments, in the hydrogen gas generator 500 of the embodiment, the liquid water 50 and the capillary structure 520 are located outside the elastic bag-like body 530 and the air-permeable opening 522 of the container 510 is communicated with the elastic bag-like body 530. The liquid water 50 may be gradually consumed from the status of FIG. 7 to the status of FIG. 8. Along with the consumption of the liquid water 50, the elastic bag-like body 530 would be expanded under the atmosphere pressure from the status of FIG. 7 to the status of FIG. 8. In this way, it is assured to make the capillary structure 520 contact the liquid water 50 and to durably transfer the liquid water 50 to the solid fuel 540 through the capillary structure 520. In addition, in the embodiment of FIGS. 7 and 8, a liquid water supplementary assembly 580 is further employed and disposed at the container 510 so as to supplement the liquid water 50.

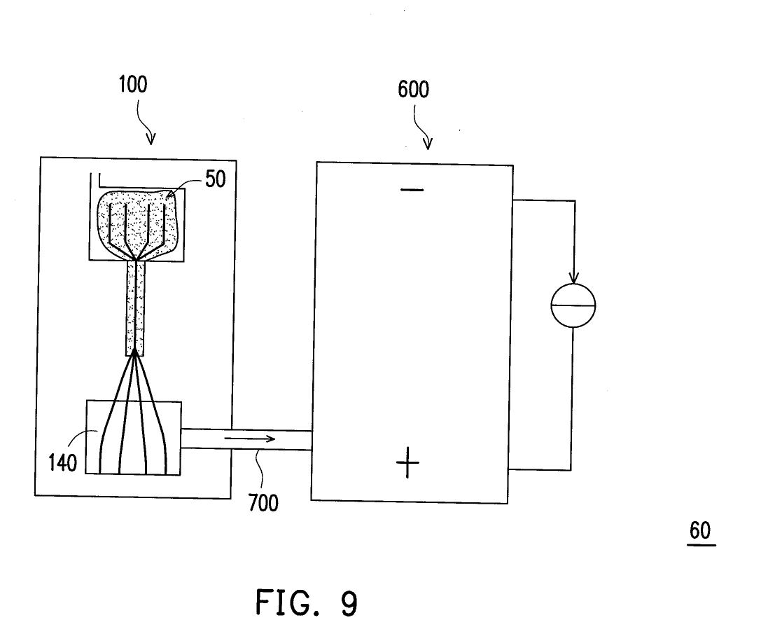

The hydrogen gas generators in all the above-mentioned embodiments are applicable to a fuel cell to provide the hydrogen gas required by the reactions at the anode of the fuel cell. In following, the hydrogen gas generator 100 of FIG. 1 is taken as an example for depiction. FIG. 9 is a diagram of a fuel cell with the hydrogen gas generator in FIG. 1. Referring to FIG. 9, the fuel cell 60 of the embodiment includes a hydrogen gas generator 100 of FIG. 1, a cell pile 600, and a guiding structure 700. The guiding structure 700 is connected between the hydrogen gas generator 100 and the cell pile 600 for guiding the hydrogen gas generated by the reaction of the solid fuel 140 and the liquid water 50 to the cell pile 600 so as to provide the hydrogen gas required by the reactions at the anode of the cell pile 600. It should be noted that the oxygen gas required by the reactions at the cathode of the cell pile 600 is provided, for example, by other supply sources, which is not depicted in the embodiment. The fuel cell 60 of the embodiment may be used in electronic apparatuses such as notebook computer or mobile phone, or transportation means such as vehicles or ships.

In summary, the above-mentioned embodiments of the invention have at least one of the following advantages. The liquid water may be durably transferred to the solid fuel through the capillary structure so that the solid fuel slowly reacts with the liquid water to stably release the hydrogen gas. The liquid water located in the container may keep contacting the capillary structure by means of the expansion and shrinking of the elastic bag-like body. In addition, a manual switch or an electroosmotic pump may be used to control the liquid water in the capillary structure for determining transferring, not transferring or transferring speed. In this way, the generating rate of the hydrogen gas by the reaction of the solid fuel and the liquid water may be adjusted.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the invention as defined by the following claims. Moreover, no element and component in the present disclosure is intended to be dedicated to the public regardless of whether the element or component is explicitly recited in the following claims.

What is claimed is:

1. A hydrogen gas generator, suitable for a fuel cell and comprising:
a container; and
a capillary structure, disposed between the container and a flexible solid fuel, wherein the container is capable of accommodating liquid water, and the liquid water accommodated in the container is capable of being transferred to the flexible solid fuel by the capillary structure so as to react with the flexible solid fuel to generate hydrogen gas.

2. The hydrogen gas generator as claimed in claim 1, wherein the container has an elastic bag-like body therein and the liquid water accommodated in the container contacts the elastic bag-like body.

3. The hydrogen gas generator as claimed in claim 2, wherein the container has an air-permeable opening and the container is communicated with the outside through the air-permeable opening.

4. The hydrogen gas generator as claimed in claim 3, wherein the liquid water and the capillary structure are located in the elastic bag-like body, the container has a fluid-guiding opening, and the fluid-guiding opening is communicated with the elastic bag-like body.

5. The hydrogen gas generator as claimed in claim 3, wherein the liquid water and the capillary structure are located outside the elastic bag-like body and the air-permeable opening is communicated with the elastic bag-like body.

6. The hydrogen gas generator as claimed in claim 1, wherein a disposing manner of the capillary structure is selected from the group consisting of enclosing the flexible solid fuel, located on the surface of the flexible solid fuel and extending into the flexible solid fuel.

7. The hydrogen gas generator as claimed in claim 1, further comprising:
an elastic pipe body, disposed between the container and the flexible solid fuel, wherein the capillary structure goes through the elastic pipe body and extends to the flexible solid fuel; and
a switch assembly, disposed beside the elastic pipe body, wherein the switch assembly is capable of squeezing the elastic pipe body for deformation so as to press the capillary structure.

8. The hydrogen gas generator as claimed in claim 1, further comprising an electroosmotic pump disposed between the container and the flexible solid fuel, wherein the capillary structure goes through the electroosmotic pump and extends to the flexible solid fuel.

9. The hydrogen gas generator as claimed in claim 1, wherein the diameter of the flexible solid fuel is greater than or substantially equal to 1 mm.

10. A fuel cell, comprising:
a hydrogen gas generator, comprising:
a container; and
a capillary structure, disposed between the container and a flexible solid fuel, wherein the container is capable of accommodating liquid water, and the liquid water accommodated in the container is capable of being transferred to the flexible solid fuel by the capillary structure so as to react with the flexible solid fuel to generate hydrogen gas;
a cell pile; and
a guiding structure, connected between the hydrogen gas generator and the cell pile and capable of transferring the hydrogen gas generated by the reaction of the flexible solid fuel and the liquid water to the cell pile.

11. The fuel cell as claimed in claim 10, wherein the container has an elastic bag-like body therein and the liquid water accommodated in the container contacts the elastic bag-like body.

12. The fuel cell as claimed in claim 11, wherein the container has an air-permeable opening and the container is communicated with the outside through the air-permeable opening.

13. The fuel cell as claimed in claim 12, wherein the liquid water and the capillary structure are located in the elastic bag-like body, the container has a fluid-guiding opening, and the fluid-guiding opening is communicated with the elastic bag-like body.

14. The fuel cell as claimed in claim 12, wherein the liquid water and the capillary structure are located outside the elastic bag-like body and the air-permeable opening is communicated with the elastic bag-like body.

15. The fuel cell as claimed in claim 10, wherein a disposing manner of the capillary structure is selected from the group consisting of enclosing the flexible solid fuel, located on the surface of the flexible solid fuel and extending into the flexible solid fuel.

16. The fuel cell as claimed in claim 10, further comprising:
an elastic pipe body, disposed between the container and the flexible solid fuel, wherein the capillary structure goes through the elastic pipe body and extends to the flexible solid fuel; and
a switch assembly, disposed beside the elastic pipe body, wherein the switch assembly is capable of squeezing the elastic pipe body for deformation so as to press the capillary structure.

17. The fuel cell as claimed in claim 10, further comprising an electroosmotic pump disposed between the container and the flexible solid fuel, wherein the capillary structure goes through the electroosmotic pump and extends to the flexible solid fuel.

18. The fuel cell as claimed in claim 10, wherein the diameter of the flexible solid fuel is greater than or substantially equal to 1 mm.
